(19) United States
(12) Patent Application Publication
(10) Pub. No.: US 2016/0025379 A1
(43) Pub. Date: Jan. 28, 2016

(54) Heating Device with an Operating Unit and Method for Operating a Heating Device

(71) Applicant: ROBERT BOSCH GMBH, Stuttgart (DE)

(72) Inventors: Sebastiaan Moes, Enter (NL); Manfred Oehrlein, Schlierbach (DE); Marcus Wuenning, Ebersbach (DE); Alexander Macho, Lenningen-Schopfloch (DE)

(21) Appl. No.: 14/774,726

(22) PCT Filed: Mar. 7, 2014
(86) PCT No.: PCT/EP2014/054449

§ 371 Date: Sep. 11, 2015

(30) Foreign Application Priority Data
Mar. 12, 2013 (DE) 102013204286.8

(51) Int. Cl. F24H 9/20; G06F 3/041; G05B 15/02

(52) U.S. Cl. CPC F24H 9/2014; G05B 15/02; G06F 3/041

(57) ABSTRACT

A heating device includes at least one heating unit, a heat transfer element, a control system, a covering, and an operating unit. The operating unit includes a touch screen configured to enable main parameters that are necessary for controlling the heating device to be displayed, selected, and manipulated.

The invention relates to a heating device having a heating unit, a heat transferring element, a controller, a casing and an operating unit.

### PRIOR ART

DE 19801081C2 disclosed a warming device that is embodied as floor heating and/or an instantaneous water heater. In this document, it is proposed to embody the device construction from a combination of planar glass and/or glass ceramic molded parts having planar sheet metal parts, wherein planar glass molded parts and/or ceramic molded parts of this type are to be provided at least in the region of the combustion chamber.

In addition, EP 2431671 discloses to provide a display in the case of an electric water heater and said display can be embodied as a touch-screen display.

The object of the invention is to embody a heating device of the type mentioned in the introduction in such a manner that in particular it is also possible for a non-trained consumer to input useful data without needing to study extensive operating instructions.

### DISCLOSURE OF THE INVENTION

The heating device in accordance with the invention having the features of the main claim has the advantage that it is possible for the operating unit in an unhindered manner to fulfill as such its function regarding receiving and further processing incoming instructions, furthermore however said operating unit comprises a touch-screen by way of which it is not only possible to accept instructions but rather also to illustrate information and provide a menu navigation.

The term “operating unit” is to be understood to mean a unit by way of which it is possible to operate a heating device, said unit in other words comprising an input device that can convert incoming instructions into commands that can be accepted by the controller. The controller can be part of the operating unit. The term “touch-screen” is understood to mean an apparatus that comprises a surface that can be used as a display that can be changed and said surface is touch sensitive and as a result of touching different sites of the display, it is possible to allocate the contents that are illustrated on the display.

Advantageous further developments of the heating device are possible in accordance with the main claim by virtue of the features that are disclosed in the dependent claims.

The operating unit is housed in a protected manner if said operating unit is attached to an inner face of the casing of the heating device.

An optimal operation is ensured if the operating unit can be operated from an outer face of the casing.

The operability can be increased if the casing comprises a transparent surface through which the operating unit is visible.

If the operating unit can be removed, on the one hand the comfort is increased and on the other hand the operability is increased, in particular because the operating unit can then also be positioned on a planar lower surface.

The functionality of the operating unit is increased if the operating unit is capable of internet access, in other words, can achieve a connection to the internet.

The invention also relates to a method for operating a heating device having an operating unit that comprises a touch-screen. The operation of the heating device is fundamentally improved if parameters that are necessary to control the heating device can be displayed, selected and influenced by way of the touch-screen.

The operation is further simplified if parameters of the heating device and/or the environment can be displayed in a table format or as a graphic.

In particular in the case of a high density of information, the method can be positively further developed by virtue of the fact that the display can be enlarged and reduced by way of the touch-screen.

The method for operating a heating device is further optimized if the operating unit can be connected to the internet.

### DRAWING

An embodiment of a heating device in accordance with the invention and also of a method for operating a heating device is illustrated in the figures and is further explained in the description hereinunder. In the drawings:

FIG. 1 illustrates a heating device in accordance with the invention in a front view,

FIG. 2 illustrates the heating device in accordance with the invention in accordance with FIG. 1 in a side view in a schematic illustration and in part in a sectional view and

FIG. 3 illustrates the sequence of a possible method for operating the heating device.

### DESCRIPTION

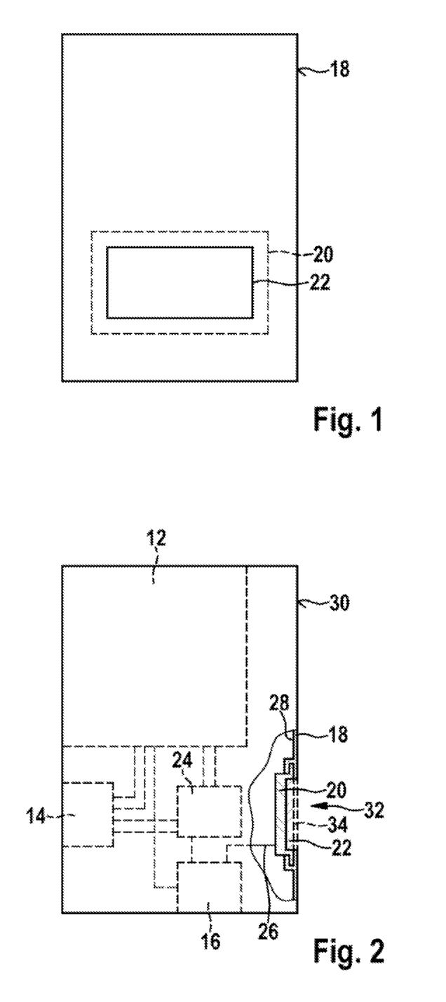

FIGS. 1 and 2 illustrate a heating device 10, the front face of which is visible in FIG. 1 and the side face of which is visible in FIG. 2. The heating device 10 comprises a heating unit 12, a heat transferring element 14, a controller 16, a casing 18 and an operating unit 20. The operating unit 20 comprises for its part a touch-screen 22.

The touch-screen 22 is integrated into the operating unit 20 in such a manner that it forms an outer surface of the operating unit 20 and can communicate with the operating unit 20. The operating unit 20 for its part is connected to the controller 16.

The schematically illustrated controller 16 is able to convert the signals that are processed by the operating unit 20 and its touch-screen 22 into control signals for a schematically illustrated hydraulic group 24 and also the heating unit 12. In addition, the controller 16 for its part can output signals to the operating unit 20 and the touch-screen 20.

The connection between the operating unit 20 and the controller 16 is embodied in the embodiment as a bus system 26.

As is evident in FIG. 2, the operating unit 20 is attached to an inner face 28 of the casing 18. The term “attached” is to be understood to mean that that said operating unit can be screwed on, bonded or also clamped on. It is also feasible that said operating unit is deposited in a bracket or a pocket.

In the exemplary embodiment, the operating unit 20 is fastened to an inner face 28 of the casing 18. The operability is ensured by virtue of the fact that the operating unit 20 can be operated from an outer face 30. This can be ensured by way of example by virtue of the fact that operating elements are guided through the casing 18 or that a wireless connection to a transmitter that is located outside the casing is provided. In the exemplary embodiment, at least the region 32 to which the operating unit 20 is attached is embodied in such a manner that any contact on the outer face 30 is transferred on to the inner face 28 and therefore to the operating unit 20. This can occur mechanically by means of deformation, electrically—by way of example by way of capacitive or inductive measurement or visually by means of recording light conditions.

In order to be able to discern information that is illustrated on the touchscreen 22, the casing 18 comprises at least in the region 32 a transparent surface 34 through which the illustrated information is visible. This surface can be by way of example an inspection window that is embodied from glass, a glass ceramic or a synthetic material.

In the exemplary embodiment, as is mentioned, the operating unit 20 is fastened to the inner face 28. This fastening is achieved as a clamp connection that can be latched so that the operating unit 20 can be removed by means of opening the clamp connection. As a consequence, it is possible to hold the operating unit in the hand or to lay said operating unit on a remote table and by way of example to connect said operating unit to a computer. Naturally, it is necessary for this purpose to open the casing 18.

The connection between the operating unit 20 and the controller 16 is separated whilst removing the operating unit 20 and is replaced by means of a wireless connection.

The operating unit 20 is constructed in the form of a small, so-called tablet PC and can be connected to the internet directly or by way of a hotspot. For this purpose, the operating unit 20 comprises an internal circuit that is capable of internet access and is not illustrated.

Naturally, it is also feasible that the controller 16 is capable of internet access and can be connected to a router by way of example by way of a LAN or a WLAN.

In order to be able to operate in an expedient manner the heating device 10 that is provided with an operating unit 20 that comprises a touch-screen 22, the fundamental parameters that are necessary to control the heating device 10 are displayed, selected and influenced in a preferred operating method by way of the touch-screen 22.

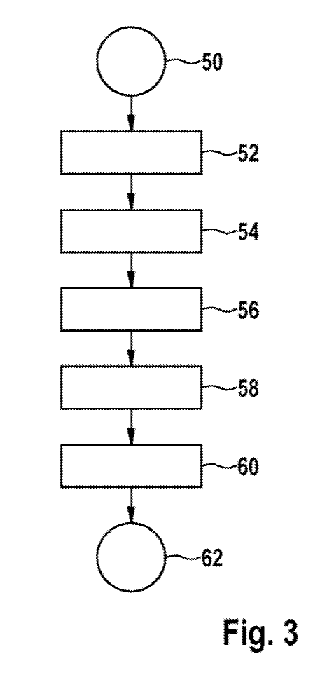

The method in accordance with the invention for operating a heating device 10 would then comprise the method steps that are illustrated in FIG. 3. In a first step 50, contact is established with the operating unit 10 and can occur by way of example by virtue of the fact that the touch-screen 22 is touched. In the second step 52, the operating unit 20 wakes up from its standby mode and in a third step 54 displays a selection menu.

Various information levels can be called up in the subsequent steps by means of individual menu points and/or sub menu points.

In a further step 56, the touch-screen 22 displays parameters in a table format and/or as a graphic, said parameters can then be used for further decision making and for operating the heating device.

If the display in particular a graphic display or the display of contact points on the touch-screen is too small for the user, said user can enlarge and also reduce the size of the display in a step 58 by way of the touch-screen 22. This all improves the comfort whilst operating the heating device.

By way of example, in order to be able to receive help during operation, it is possible in a further step by way of the touch-screen 22 to connect to the internet directly or by way of a router. The further functions are then provided by the selected homepage.

In a last step 62, the operating unit 20 goes into a standby mode after a prolonged period of non-use of the touch-screen 22.

The illustrated details of the heating device 10 in accordance with the invention and also the method for operating the heating device 10 will be adapted individually or combined in groups by the person skilled in the art according to his requirements.

1. A heating device comprising:
at least one heating unit;
a heat transferring element;
a controller;
a casing; and
an operating unit including a touch-screen.

2. The heating device as claimed in claim 1, wherein the operating unit is attached to an inner face of the casing.

3. The heating device as claimed in claim 2, wherein the operating unit is configured for operation from an outer face of the casing.

4. The heating device as claimed in claim 2, wherein the casing comprises a transparent surface through which the operating unit is visible.

5. The heating device as claimed in claim 2, wherein the operating unit is configured for removal from the inner face.

6. The heating device as claimed in claim 1, wherein the operating unit is configured for connection to the internet directly or indirectly.

7. A method for operating a heating device having an operating unit that includes a touch-screen comprising:
displaying, selecting, and influencing fundamental parameters that are necessary to control the heating device by way of the touch-screen.

8. The method as claimed in claim 7, further comprising:
displaying the fundamental parameters on the touch-screen in table format or as a graphic.

9. The method as claimed in claim 7, further comprising:
enlarging or reducing a display shown on the touch-screen by way of the touch-screen.

10. The method as claimed in claim 7, further comprising:
connecting the operating unit to the internet, or
providing a connection to the internet.
